(19) United States
(12) Patent Application Publication
(10) Pub. No.: US 2013/0077172 A1
(43) Pub. Date: Mar. 28, 2013

(54) Sight Device and Inner Tube with Light-Extinction Structure

(71) Applicant: Chen-Yeh Lin, Taichung City (TW)

(72) Inventor: Chen-Yeh Lin, Taichung City (TW)

(73) Assignee: ASIA OPTICAL CO., INC., Taichung City (TW)

(21) Appl. No.: 13/476,322

(22) Filed: May 21, 2012

(30) Foreign Application Priority Data
Sep. 28, 2011 (TW) 100135040

(51) Int. Cl. G02B 7/10

(52) U.S. Cl. 359/601

(57) ABSTRACT

A sight device with a light-extinction structure includes a zooming outer tube, an inner tube and a zooming group. The inner tube is disposed coaxially in the zooming outer tube, and the zooming group is composed by a plurality of lenses, and the zooming group is disposed inside the inner tube and is controlled by the zooming outer tube, and thus the lenses are allowed to move inside the inner tube for adapting a focal length of the zooming group.

### RELATED APPLICATIONS

The application claims priority to Taiwan Application Serial Number 100135040, filed Sep. 28, 2011, which is herein incorporated by reference.

### BACKGROUND

1. Technical Field

The present disclosure relates to an optical sight device. More particularly, the present disclosure relates to an inner tube of the optical sight device.

2. Description of Related Art

An optical sight device is composed of a zooming outer tube, an inner tube and a zooming group lens set. The zooming group lens set which is arranged inside the inner tube and controlled by the zooming outer tube is axially moved inside the inner tube for adapting a focal length of the zooming group. In order to allow the zooming group lens set to move more smoothly inside the inner tube, an inner surface of the inner tube has to be smooth for the zooming group lens set to moves smooth therein. However, the smooth inner surface also means a good optical reflector. Therefore, when incident light passes through the inner tube to enter an optical instrument for imaging, stray light will enter the optical instrument after being continuously reflected inside the inner tube, thus interfering with imaging.

### SUMMARY

According to one embodiment of the present invention, a sight device with a light-extinction structure includes a zooming outer tube, an inner tube and a zooming group. The inner tube is coaxially disposed in the zooming outer tube, and the zooming group is composed of a plurality of lenses, and the zooming group is disposed inside the inner tube and is controlled by the zooming outer tube, thus allowing the lenses to be moved inside the inner tube for adapting a focal length of the zooming group.

The inner tube has a light-extinction surface, a plurality of axial sliding ribs and an axial groove. The axial sliding ribs and the axial groove are formed on the light-extinction surface, and the axial groove is used to restrict a non-axial displacement of the zooming group, and the axial sliding ribs enable the zooming group to move axially, and the light-extinction surface is used to eliminate stray light inside the inner tube.

According to another embodiment of the present invention, a sight device with light-extinction structure includes a zooming outer tube, a light-extinction surface and a plurality of axial sliding ribs. The zooming outer tube controls a movement of a plurality of lenses disposed inside an inner tube. The light-extinction surface is formed on an inner surface of the inner tube for eliminating stray light inside the inner tube. The plurality of axial sliding ribs is arranged on the light-extinction surface for enabling the lenses to move axially inside the inner tube.

According to another embodiment of the present invention, a light-extinction inner tube is allowing at least one lens to move inside the inner tube, and the inner tube includes a tube body, a light-extinction surface and a plurality of axial sliding ribs. The light-extinction surface is formed on an inner surface of the tube body for eliminating stray light inside the tube body. The plurality of axial sliding ribs is formed on the light-extinction surface for holding the lens and enabling the lens to move axially inside the tube body.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic structure diagram of a sight device with a light-extinction structure according to one embodiment of the present invention; and

FIG. 2 is a schematic structure diagram of an inner tube shown in FIG. 1.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically depicted in order to simplify the drawings.

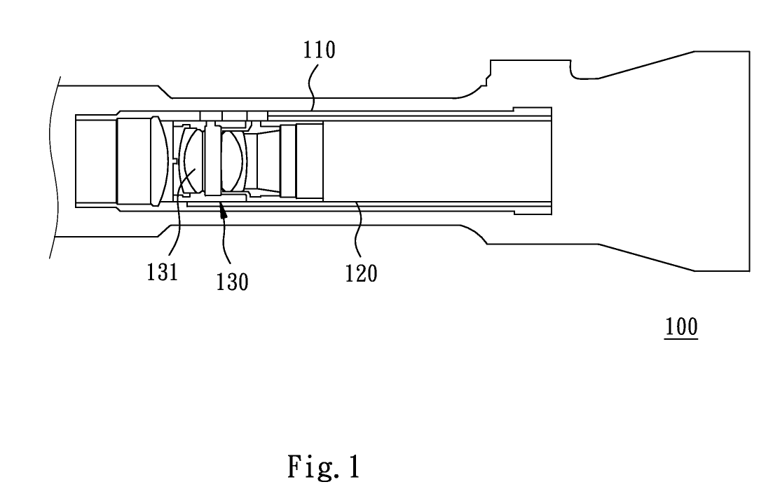

FIG. 1 is a schematic structure diagram of a sight device with a light-extinction structure according to one embodiment of the present invention. As shown in FIG. 1, a sight device 100 includes a zooming outer tube 110, an inner tube 120 and a zooming group 130. The inner tube 120 is disposed inside the zooming outer tube 110, and the zooming group 130 is composed of a plurality of lenses 131, and the zooming group 130 is coaxially disposed inside the inner tube 120 and is controlled by the zooming outer tube 110, and thus the lenses 131 can be moved axially inside the inner tube 120 for adapting a focal length of the zooming group 130.

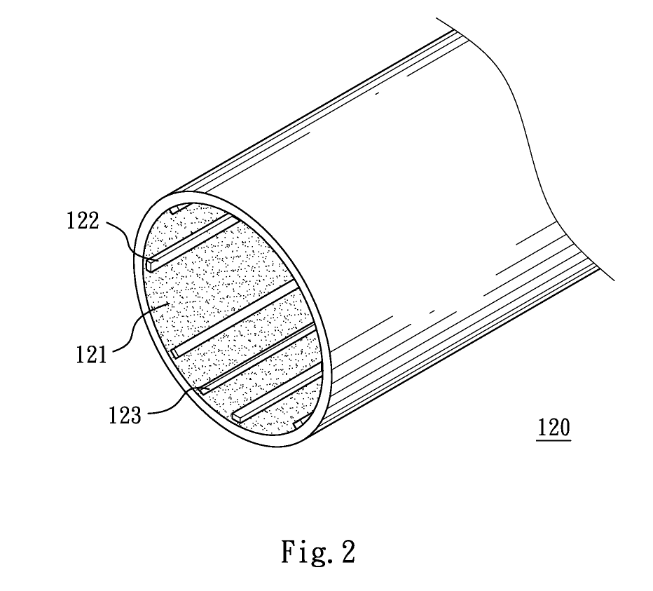

FIG. 2 is a schematic structure diagram of the inner tube 120 shown in FIG. 1. As shown in FIG. 2, the inner tube 120 has a light-extinction surface 121, a plurality of axial sliding ribs 122 and an axial groove 123. The axial groove 123 and the axial sliding ribs 122 are formed on the light-extinction surface 121, and the axial groove 123 is used to restrict a non-axial displacement of the zooming group 130, and the axial sliding ribs 122 holds the zooming group 130 with a smooth surface and enables the zooming group 130 to move axially and smoothly, and the light-extinction surface 121 is used to eliminate stray light inside the inner tube 120.

From another point of view, a sight device with light-extinction structure 100 includes a zooming outer tube 110, a light-extinction surface 121 and a plurality of axial sliding ribs 122. The zooming outer tube 110 controls the movement of a plurality of lenses 131 disposed inside an inner tube 120; the light-extinction surface 121 is formed on an inner surface of the inner tube 120 for eliminating stray light inside the inner tube 120; the axial sliding ribs 122 is arranged on the light-extinction surface 121 for enabling the lenses 131 to move axially inside the inner tube 120.

From still another point of view, according to another embodiment of the present invention, a light-extinction inner tube 120 is allowing at least one lens 131 to move inside the light-extinction inner tube 120. The light-extinction inner tube 120 includes a tube body, a light-extinction surface 121 and a plurality of axial sliding ribs 122. The light-extinction surface 121 is formed on an inner surface of the tube body for eliminating stray light inside the tube body; the axial sliding ribs 122 are formed on the light-extinction surface 121 for holding the lens 131 and enabling the lens 131 to move axially inside the tube body.

It is worthy to be noted that the light-extinction surface 121 can be a matted surface with complete light-extinction. Furthermore, the axial sliding ribs 122 can be designed to protrude from the light-extinction surface 121, and the light-extinction surface 121 can be a rough anti-reflective surface as well. Moreover, in order to apply uniform force on the lens 131 during the movement of the lens 131, the axial sliding ribs 122 are equidistantly arranged on the light-extinction surface 121, such as being arranged in a regular hexagon or regular octagon.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A sight device with a light-extinction structure, the sight device comprising:
a zooming outer tube, an inner tube and a zooming group, wherein the inner tube is coaxially disposed in the zooming outer tube, and the zooming group is composed of a plurality of lenses, and the zooming group is disposed inside the inner tube and is controlled by the zooming outer tube, thereby allowing the lenses to be moved inside the inner tube for adapting a focal length of the zooming group;
wherein, the inner tube has a light-extinction surface, a plurality of axial sliding ribs and an axial groove, and the axial sliding ribs and the axial groove are formed on the light-extinction surface, and the axial groove is used to restrict a non-axial displacement of the zooming group, and the axial sliding ribs enable the zooming group to move axially, and the light-extinction surface is used to eliminate stray light inside the inner tube.

2. The sight device with light-extinction structure of claim 1, wherein the light-extinction surface is a matte surface with complete light-extinction.

3. The sight device with light-extinction structure of claim 1, wherein the axial sliding ribs are equidistantly arranged on the light-extinction surface.

4. A sight device with a light-extinction structure, the sight device comprising:
a zooming outer tube for controlling a movement of a plurality of lenses disposed inside an inner tube;
a light-extinction surface which is formed on an inner surface of the inner tube for eliminating stray light inside the inner tube; and
a plurality of axial sliding ribs which are arranged on the light-extinction surface for enabling the lenses to move axially inside the inner tube.

5. The sight device with light-extinction structure of claim 4, wherein the light-extinction surface is a matte surface with complete light-extinction.

6. The sight device with light-extinction structure of claim 4, wherein the axial sliding ribs are equidistantly arranged on the light-extinction surface.

7. An inner tube with a light-extinction structure for allowing at least one lens to move therein, the inner tube comprising:
a tube body;
a light-extinction surface which is formed on an inner surface of the tube body for eliminating stray light inside the tube body; and
a plurality of axial sliding ribs which are formed on the light-extinction surface for holding the lens and enabling the lens to move axially inside the tube body.

8. The light-extinction inner tube of claim 7, wherein the light-extinction surface is a matte surface with complete light-extinction.

9. The light-extinction inner tube of claim 7, wherein the axial sliding ribs are equidistantly arranged on the light-extinction surface.
